(19) United States
(12) Patent Application Publication
(10) Pub. No.: US 2011/0078764 A1
(43) Pub. Date: Mar. 31, 2011

(54) TIGHT COUPLING SIGNALING CONNECTION MANAGEMENT FOR COUPLING A WIRELESS NETWORK WITH A CELLULAR NETWORK

(76) Inventor: Guillaume BICHOT, La Chapelle (FR)

(21) Appl. No.: 12/958,922

(22) Filed: Dec. 2, 2010

Related U.S. Application Data
(62) Division of application No. 10/549,299, filed on Sep. 15, 2005.

(51) Int. Cl. G06F 21/00; G06F 15/16

(52) U.S. Cl. 726/3

(57) ABSTRACT

A method for communicating between a cellular system and a client terminal such as a mobile terminal by way of a standard wireless LAN and the Internet allows data communications to traverse the core of the cellular network, thereby allowing monitoring of the time and volume usage by the subscriber for billing purposes. The mobile terminal has a communication protocol for communicating with the wireless LAN, over which is a EAP/EAPOL protocol. A Radio Adaptation Layer protocol overlies the EAP/EAPOL protocol. At the cellular system, a Serving GPRS Support Node establishes initial control contact with the mobile terminal by way of EAP/EAPOL. During authentication, the Support Node gives the mobile terminal parameters for an alternative tunnel connection. Once authorization is complete, the mobile terminal closes the EAP/EAPOL connection and opens a new connection tunnel to the Support Node using the parameters.

### CLAIM FOR PRIORITY

This application claims the benefit of provisional patent application Ser. No. 60/455,615 entitled “A 3GPP/GPRS Signaling Connection Management Compatible with the IEEE 802.1x Model”, incorporated herein by reference in its entirety.

### FIELD OF THE INVENTION

The invention relates to communications between a client terminal such as a mobile terminal, and a cellular communication system by means of a wireless network, for example, a wireless LAN according to the IEEE 802.11 standards. The wireless may communicate with the cellular system by means of the Internet. The invention is also applicable where the communications is through a private network. The client terminal is attached to the cellular communication system through an access point of the wireless network.

### BACKGROUND OF THE INVENTION

Public Wireless Local Area Networks (WLAN) systems are becoming more common, but the WLAN systems are for the most part independently operated and controlled. Thus, there are many separate owner/operators of WLAN systems. Each separately controlled system is termed a “domain.” Because of the large number of owner/operators or domains, it is difficult or impossible for a user to subscribe to all the different WLAN systems to which connection may be made, especially in view of the fact that the potential user may become aware of the existence of a wireless local area system in a particular area only when his portable communication device announces its availability. In order to ameliorate this situation and to provide improved service, some service providers aggregate, in some way, two or more separate WLAN systems by entering into agreements with other providers.

A communications service provider may provide various different kinds of service. In those cases in which the communications service provider is a cellular communications network (3GGP or cellphone service) provider, the provider may make available Internet-only access, with the user authenticated by the cellular network but Internet access by way of the Wireless Local Area Network (WLAN). In such Internet-only WLAN service, the Internet data, or user data, never traverses or moves over the cellular system. However, the authentication, authorization, and accounting control data relating to the Internet service may traverse the cellular system. The term “loose coupling” is applied to communications in which only the control data or information traverses the cellular system, but not the user data itself. The loose coupling arrangement has the disadvantage that the cellular and WLAN systems are substantially independent, and the cellular system operator therefore does not have any ready access to information about the time usage of the WLAN system, or the volume of data, either or both of which may be useful in customer billing. Moreover the user cannot access to any cellular network specific services like SMS.

Another possible type of communication service is full cellular network access, in which the user data and the control information both traverse the cellular network. In such service, the WLAN acts as a radio network portion of the cellular network and the user has access to the full cellular network service set, including Internet access and specific services like SMS. This type of communication is known as “tight” coupling. While theoretically appealing and potentially advantageous to the user and service provider, tight coupling has been considered by the various standardization groups to be too complex, as the protocols and requisite infrastructure may adversely complicate the WLAN. Notwithstanding their disadvantages, standards bodies such as the European Telecommunication Standard Institute (ETSI), Institute of Electrical and Electronic Engineers (IEEE), and 3^{rd} Generation Partnership Project (3GPP) are currently focused on the loose coupling model due to its relative simplicity.

FIG. 1 is a simplified functional block diagram of a prior art GPRS 3GPP digital cellular telecommunications system designated generally as 10. In general, such a system adheres to standards for digital cellular telecommunication system (Phase 2+)(GSM); Universal Mobile Telecommunications System (UMTS); General Packet Radio Service (GRPS); Service description; Stage 2 (3GPP TS 23.060 version 3.7.0 Release 1999. The system 10 of FIG. 1 includes a radio access network (RN or RAN) 12 and a core network (CN) 14. The radio access network 12 gathers together or includes a set 16 of Radio Network Controllers (RNC), some of which are illustrated as 16a and 16b. Each radio network controller (RNC) of set 16, such as RNC 16b, controls at least one “base station” or “Node B.” In FIG. 1, RNC 16b controls a set 18 including node B base stations 18a and 18b. Each node B base station corresponds to a cell of the cellular system. Each node B base station or cell communicates by wireless (radio) means with one or more mobile users via one or more client terminals or mobile terminals (UE), one of which is designated 20, located in the zone of the corresponding cell, as suggested by the “lightning bolt” symbol 22. Note that throughout the application, the term mobile terminal refers to a client terminal device, such as is designated UE in the figures.

The core network (CN) 14 of the telecommunications system 10 of FIG. 1 includes a set 30 of Serving GPRS Support Nodes (SGSN), two of which are designated 30a and 30b. Each SGSN of set 30 provides services for managing the connection between the core network 13 and the user 20, by way of the radio network controller 12. In this context, management of the connection refers to management of connection, authentication, and mobility. In this context, connection management refers to the process of provisioning network resources such as radio resources, memory, and priority in order to be able to transmit data. Mobility is the set of protocols/processes, which allow the user to move among several cells, and is also known as handover. Each SGSN also serves as a “front end,” providing the user 20 with access to other 3G services such as Short Messaging System (SMS).

The Serving GPRS Support Nodes (SGSN) of set 30 of SGSNs of core network 14 of FIG. 1 communicate with a Home Location Register (HLR) which is illustrated as an external memory 40. The HLR 40 is the database that includes all relevant information relating to each subscriber to the network 10. The SGSN of set 30, as for example SGSN 30a, identifies and authenticates a user by reference to the HLR 40.

The Gateway GPRS Support Node (GGSN) 32 of core network 14 of FIG. 1 provides interconnection between core network 14 and an external Internet-Protocol (IP) based Packet Data Network (PDN) 110, such as the Internet.

The system 10 of FIG. 1 also includes a Border Gateway (BG) 34 in core network 14. Border gateway 34 is a function, which allows the user to roam between or among GPRS networks belonging to different domains (operators). Border Gateway 34 is connected to an external Public Land Mobile Network (PLMN) 134 which may comprise a cellular network.

In operation of system 10 of FIG. 1, the RNCs 16a, 16b of set 16 implement the interface between the core network 14 and the radio network.

FIG. 2a is a simplified illustration of the control protocol stacks of the mobile terminal (UE) 20, the node B of set 18, the Radio Network Controllers (RNC) of set 16, and the Serving GPRS Support Nodes (SGSN) of set 30, and FIG. 2b illustrates a sequence of the successive protocol operations for opening a user data channel between the mobile terminal and SGSN of FIG. 2a. In FIG. 2a, protocols associated with the mobile terminal UE are designated generally as 220, protocols associated with the Node B are designated generally as 250, protocols associated with the RNC are designated generally as 216, and those associated with SGSNs are designated generally as 230. The radio interface between the mobile node UE and the Node B corresponds to one of the standardized 3G cellular radio interface, such as WCDMA. In the mobile terminal UE, the MAC (Medium Access Control) protocol in conjunction with the RLC (Radio Link Control) protocol allows the transport of information, whatever its nature (i.e. user data or control). The RRC (Radio Resource Control) protocol is used between the UE and the RNC for radio connection control (creation, removal, andor modification of the connection). The GMM (GPRS Mobility Management) protocol and CM (Connection Management) protocols are used between the mobile terminal and the SGSN for respectively mobility management (authentication and handover) and user data connection management. The Node B (or base station) is under the control of an RNC through the usage of a set of protocols, which are not represented in FIG. 2a. The RNC is controlled by the SGSN by means of the RANAP (RAdio Network Application Protocol) protocol that is carried by a protocol stack based on ATM (Asynchronous Transfer Mode) not depicted. The SGSN communicates with the GGSN 32 of FIG. 1 for control purposes by means of the GTP-C (GPRS Tunneling Protocol-Control) that is carried by a protocol stack based on the TCP/IP protocol stack. FIG. 2b represents a sequence diagram of the successive protocol operations in order to open a data user channel between the mobile terminal and the SGSN.

Initially, a mobile terminal UE such as terminal 20, once switched on, catches or captures broadcast downlink information, thereby allowing the UE to send an attachment request to the SGSN through a physical transmission opportunity. The SGSN immediately opens a signaling channel used only for control purposes. This process is not depicted in FIG. 2b and is represented as a first step by a numeral 1 within a circle. Once the basic signaling (or control) channel is set up, the mobile terminal UE requests a user data connection characterized by means of QOS (Quality Of Service) parameters or by means of a Connection Management (CM) protocol (step 2 in FIG. 2B). The appropriate SGSN, such as SGSN 30a of FIG. 1, verifies the request (determines if the mobile terminal is authorized for the requested service) and requests through, or by means of, the Radio Access Network Protocol (RANAP) that an associated RNC, which in this case could be RNC 16b, establish the radio connection associated with the QOS parameters (circled step “3” in FIG. 2b). The RNC (16b in this case) translates the QOS parameters into parameters which are used to establish the corresponding radio connection in both the base station (Node B 18a in this case) and the mobile terminal UE, corresponding to circled step 4 in FIG. 2b). The RNC controls the terminal by means of the Radio Resource Control (RRC) protocol. The UE 20 and the Node B 18a use the parameters transmitted by the RNC (carry them without change) to configure their respective radio protocol layers, including Radio Link Control (RLC), Medium Access Control (MAC), and physical layers. The radio channel is then established (circled step 5 in FIG. 2b). Both the Node B 18a and the mobile terminal UE confirm the operation, and the RNC acknowledges the operation to the SGSN (circled step 6 in FIG. 2b). Last, the SGSN acknowledge the success of the operation to the mobile terminal using the CM protocol (circled step 7 in FIG. 2b).

FIG. 3 is a simplified representation of 3G GPRS user data protocol stack. User data (not illustrated) originating at the mobile terminal UE, which may, for example, be in Internet-Protocol (IP) form, is transported between the mobile terminal UE and the SGSN using the Packet Data Compression Protocol (PDCP), which compresses the IP header in order to conserve some bandwidth. Between the RNC stack and the SGSN stack 330, and within the remainder of the core network 14 of FIG. 1 up to the stack (not illustrated in FIG. 3) of the GGSN of FIG. 1, the user data is carried by GPRS Tunnel Protocol (GTP) that is implemented over UDP/IP. The user data carried over GPRS Tunnel Protocol implemented over UDP/IP does not operate on the user data, so the user data may be viewed as simply passing through (or bypassing) the RNC and SGSN, as represented in FIG. 3 by path 390.

FIG. 4 is a conceptual representation of the 3G-WLAN loose coupling scenario as envisaged by the different standards bodies. In FIG. 4, the Internet is illustrated as a cloud or circle 410, the public WLAN system as a cloud or circle 412, and the 3G core network, corresponding to 14 of FIG. 1, is designated 414. Additionally, FIG. 416 shows a representative web server 416 and a mobile terminal 420, corresponding to user 20 of FIG. 1. In the prior-art scenario represented by FIG. 4, user 420 is within the coverage region of public WLAN 412.

When the mobile terminal 420 of FIG. 4 is turned ON so as to make a connection request illustrated as 430, the WLAN 412 detects this fact, and directs or redirects the connection request by way of a control path 428 through the Internet 410 toward an Authentication, Authorization, and Accounting (AAA) portion 424 of the core network 414. AAA 424 consults its Home Location Register 40 to determine if the data associated with mobile terminal 420 corresponds with that of an authorized user. After being authenticated, the AAA 424 authorizes the WLAN, which is the access point, to let the user data traffic through the access point. The user is then able to use the Internet, as by browsing, by way of a data path 426 communicating with web server 416.

In the communication domain, the protocols are split among three different planes, namely Management, Control and User. The Management protocols provide a way to configure the equipments. The Control protocols provide a way to dynamically control/command the equipments (e.g. connection establishment). The user plane protocols provide a way to carry user data. The three protocol stacks may include common protocols, especially those relative to the transport of information. FIG. 5 shows the Control plane protocol stack in case of the prior art loose coupling model. The corresponding User plane protocol stack based on TCP/IP/Ethernet corresponds with the prior art and is not represented, but is simply IP over Ethernet over the Wireless Local Area Network Medium Access Control WLAN MAC (IEEE 802.11 in our example).

The control protocol stacks associated with the mobile terminal 420, the Access Point (AP) 412, and the AAA server 424 of FIG. 4 are represented in FIG. 5 as 520, 516, and 530, respectively. FIG. 5 assumes a radio interface based on an IEEE 802.11 standard between the mobile terminal 520 and the AP 516, but it can be also other WLAN protocols, such as the ETSI Hiperlan2 protocol. As illustrated in FIG. 5, EAPOL information is transmitted between the mobile terminal 520 and the access point 516. EAPOL refers to EAP Over LAN, where the LAN is the public WLAN. EAPOL is a standardized (IEEE 802.1X) protocol that is used to carry EAP packets within Ethernet frames. “EAP” stands for Extended Authentication Protocol, which is a simple protocol, which can be used to carry any kind of authentication protocol. The authentication protocol may any kind as, for instance, the EAP AKA and EAP SIM that might be chosen by the 3GPP standard body. The DIAMETER protocol is a well-known IETF protocol (RFC 3588) used to control the authorization of the user by the AAA. It could be replaced by other equivalent protocols, such as the RADIUS protocol (RFC 2138). Once the mobile terminal 520 is authenticated, meaning that the AAA server 424 of FIG. 4 retrieved a corresponding entry in its Home Location Register or subscription database 40 and the authentication protocol succeeded, the AAA server 424 (530 of FIG. 5) sends a DIAMETER message to the AP 412 (516 of FIG. 5) in order to unblock the Ethernet traffic corresponding to the authenticated mobile terminal 420 (520 of FIG. 5).

The prior art presented above shows that for WLAN-cellular network inter-connection, the loose coupling model is simple, but the relative simplicity is associated with some undesirable limitations or problems. These include the fact that the authentication protocol is new (IEEE 802.1x, EAP, . . . ) and consequently requires a new equipment (AAA server 424 in FIG. 4) inside the cellular network, and new interfaces with legacy equipments (HLR 40 in FIG. 4), all compliant with the new paradigm. In addition, a mobile terminal equipment like a cellular phone must include two different protocol stacks, depending upon whether the attachment is done through the conventional cellular radio interface (22 in FIG. 1) or through the WLAN radio interface (FIG. 7). Further, the loose coupling model prevents access to cellular network specific services like SMS (Shot Messaging System).

Another arrangement described in U.S. Provisional Patent Application 60/455,615, filed Mar. 18, 2003 in the name of Bichot, and in a corresponding PCT application filed Feb. 27, 2004 and entitled WLAN TIGHT COUPLING COMMUNICATION USING INTERNET implements a tight coupling model in which, as in the loose coupling model, the mobile terminal UE is attached or communicates through a WLAN as an access point. The WLAN itself communicates with the cellular network through the Internet, or a private network. The protocol stack in a WLAN has a protocol stack which is (or at least can be) identical to that used in the case of loose coupling, and therefore a WLAN which is (or can be) used for the loose coupling model can also handle tight coupling traffic without any modification. A further advantage which is not found in the loose coupling model, is that the signaling (control) protocols in the mobile terminal and the SGSN, which are used to manage user data connections and to manage mobility (including authorization), are those already standardized by cellular network specifications such as the CM (Connection Management) and the GMM (GPRS Mobility Management) protocol. In order to avoid the complexity of the radio control protocols (RRC in FIG. 2a) linked with the cellular network radio interface (22 in FIG. 1) technology and its complete redesign, a simplified protocol called RAL (Radio Adaptation Layer) is defined. This new protocol is very similar to the RANAP (FIG. 2a) protocol, and thus is readily implemented. In contradistinction to the loose coupling scenario set forth in conjunction with FIGS. 1, 2a, 2b, 3, 4, and 5, connection requests from the SGSN to the mobile terminal UE by mean of this RAL protocol directly provide QOS parameters to the mobile terminal, and the mobile terminal translates these parameters into radio dependent parameters. Also, as described below in conjunction with FIG. 8, the transport of user data is compliant with the conventional model, described above in conjunction with FIG. 3, in which the transport protocol GTP-U is used between the SGSN and the mobile terminal UE, thereby implying no change in the SGSN.

FIG. 6 is a simplified representation of the flow of control information and data in the above-mentioned applications in the name of Bichot. In FIG. 6, elements corresponding to those of FIG. 4 are designated by like reference alphanumerics. As illustrated in FIG. 6, the control information, including the request for access by the mobile terminal 620, flows between the mobile terminal 620 and the core network 630 of a cellular communications system 600 by means of a control path 628, which passes through the public WLAN 412 and the Internet 410. Data flowing between mobile terminal 620 and a remote web server illustrated as 416 flows by a data path 626a through the WLAN 412, Internet 410, and core network 630, and then by a further path 626b between core network 630 and web server 416, again by way of Internet 410.

FIGS. 7 and 8 illustrate the control and data protocol stacks, respectively, for enabling the connectivity functions expressed in FIG. 6. In FIG. 7, 720 designates the control protocol stack for the mobile terminal UE (620 of FIG. 6), 730 the control protocol stack for the SGSN (630 of FIG. 6), and 760 the control stack for the access point (AP). The protocol stack of access point AP of FIG. 7 remains the same as that of a prior-art wireless LAN. Comparison of the protocol stacks of FIG. 7 with those of the loose coupling solution, as illustrated in FIG. 2a, shows that all the protocols related to the radio link, namely stacks 250 and 252, have disappeared. The 3GPP UMTS Radio Access Network Adaptation Protocol (RANAP) used in the arrangement of FIG. 2a is replaced in FIG. 7 by Radio Adaptation Layer Protocol (RALP), which is a subset of RANALP, plus some extra commands related to encryption.

Most of the RALP messages are based on RANALP. Therefore, the RALP header contains information that indicates the format of the message. The general RALP message format includes (a) version number, (b) integrity check information (only when integrity protection is required), and (c) remaining information elements (IE).

Thus, the Radio Adaptation Layer (RAL) entity of UE 720 and SGSN 730 performs the functions of the RANAP. The RALP control information is transmitted between mobile terminal UE 720 of FIG. 7 and SGSN 730 of FIG. 7 by way of access point (AP) 760, but the RALP control information is not processed by the access point, so control information essentially flows directly between the UE and the SGSN, as suggested by path 761.

In FIG. 7, note that the access point (AP) 760 is configured, or has protocol stacks, exactly as set forth in conjunction with the “loose coupling” solution of FIG. 5. More particularly, the access point (AP) 516 of FIG. 5 communicates with the mobile terminal with physical radio equipment and the EAPOL/WLAN protocol, corresponding to the left portion of AP stack 760 of FIG. 7. Similarly, access point 516 of FIG. 5 communicates with the Authentication, Authorization, and Accounting (AAA) portion 530 of the core network 414 of FIG. 4 by means of a physical level (not expressly illustrated) together with Diameter/TCP-IP protocols, which is identically the protocol stack represented on the right side of the AP stack 760 of FIG. 7. Also note that the authentication protocol and the other control protocols set forth in FIG. 7 are those already specified by the 3G cellular specification document, and more particularly by the 3GPP UMTS: connection management SM and SMS specifications and GMM as introduced in the first section of that document. Consequently, a wireless LAN access point can operate in the above-described arrangement without any substantive modification, which is a major advantage.

When a mobile terminal UE moves into the coverage area of a wireless LAN, or is initially switched ON in such a coverage area, it first establishes an EAP connection with a remote server (SGSN in this case) in conformance with the procedure discussed in relation to the loose coupling scenarios. The access point authorizes or carries only the control or EAP traffic. When the UE is authenticated according to the relevant protocol, such as 3G GPRS protocol (GMM), the SGSN 730 authorizes the user's traffic by sending a DIAMETER message, known in the art, to the access point (AP) 760, using the procedure followed by the AAA server 424 in the loose coupling scenario.

When the mobile terminal UE 720 requests connection by means of the connection management (CM) protocol, the SGSN 730 processes the request and, using the RALP protocol, requests that the mobile unit establish the radio part of the connection, by which data can be communicated. In response to the request, the mobile terminal UE 720 translates the request into parameters, which are used to establish the corresponding radio connection, ultimately completed by way of the WLAN protocol.

FIG. 8 illustrates the data protocol stacks for the user plane. Comparing the stacks of FIG. 8 with the 3G GPRS stacks of FIG. 3, it can be seen that all the protocols relating to the GPRS radio network are absent. The illustrated data stacks for the mobile terminal, the access point, and the SGSN are designated 820, 860, and 830, respectively. The radio control functions of the RNC are embedded in the control stack of the mobile terminal by virtue of the above-described protocol structure.

In the data stack arrangement of FIG. 8, the GPRS Tunneling Protocol over UDP/IP (GTP-U) is “directly” connected between the mobile terminal UE 820 and the SGSN 830, in that the information is coupled between mobile terminal UE 820 and server SGSN 830 by way of access point AP 860, but the access point 860 does not process the information, so the information in effect flows between the mobile terminal UE 820 and the server SGSN 830 directly, as suggested by path 888. The GTP protocol is carried over UDP/IP as specified by the 3GPP standard. GTP encapsulates user data packets, such as, for example, IP datagrams. The user data packets are carried transparently by the access point AP 860, and by the SGSN 830 up to GGSN 32 (FIG. 1) that performs the function of an IP router.

The “tight” communication system provides mobility for the client terminal, which is inherent in the GMM protocol. It is also inherently capable of full 3G GPRS service, full accounting, and security, all inherent in the GMM protocol.

The coupling is realized or accomplished through an Internet Protocol (IP) based network, which may be the Internet, and that the solution is compatible, at least as to the WLAN, with the loose coupling solution as currently envisaged by 3GPP SA2, IEEE 802.11i or ETSI/BRAN.

### SUMMARY OF THE INVENTION

A method according to an aspect of the invention is for establishing a signaling (control) connection between a client terminal and a communications network. The method comprises the steps of establishing an authentication connection between the client terminal and the communications network, and transmitting an authentication message from the communications network to the client terminal. The method includes the further step of transmitting set-up parameters from the communications network to the client terminal, where the set-up parameters include information useful for establishing a signaling connection between the client terminal and the communications network by means of a dedicated tunnel. The dedicated tunnel is established using the set-up parameters. Signaling information is transmitted between the client terminal and the communications network by way of the dedicated tunnel, and the authentication connection is closed. This aspect of the invention may include the step of transmitting from the client terminal to the communications network acknowledgement of receipt of the set-up parameters. The step of closing the authentication connection may be performed in response to the establishing of the dedicated tunnel.

In a particularly advantageous mode of the method according to this aspect of the invention, the client terminal is a mobile terminal and the communications network is a 3G network. In such a mode, the step of establishing an authentication connection between the client terminal and the communications network may be performed by way of a path including a wireless network which complies with IEEE 802.11 standards. The step of establishing an authentication connection between the client terminal and the communications network may include the steps of establishing EAPOL and DIAMETER connections. In a particularly advantageous mode of this aspect of the invention, the dedicated tunnel is a GTP tunnel, and the step of transmitting set-up parameters includes the step of transmitting at least one of an IP address and a tunnel ID, and possibly both, and may also include the step of transmitting QOS parameters.

A method according to an aspect of the invention is for implementing tight coupling communications. The method comprises the step of providing a wireless local area network access point having protocol stacks suitable for operation with a loose coupling arrangement. An EAP/EAPOL connection is initially established by way of the wireless local area network access point between a mobile terminal and a cellular system server. The path is for the flow of authentication and control information, including parameters for a tunnel. Following authentication by the server, the EAP/EAPOL connection is closed, and a corresponding tunnel connection is opened using the parameters. In a particular mode of this method, the step of establishing an EAP/EAPOL connection includes the step of transmitting parameters for a GTP tunnel, and the step of opening a corresponding tunnel connection includes the step of opening a GTP tunnel.

In various modes of the method, the step of closing the EAP/EAPOL path is performed before, concurrently with, or after the tunnel is opened. Authorization may be transmitted to the access point to pass user data for the mobile terminal following authentication by the server. This transmittal of authorization may be performed using DIAMETER protocol. The success of the authentication may be reported to the mobile terminal.

### BRIEF DESCRIPTION OF THE DRAWING

FIG. 1 is a simplified functional block diagram or architecture of a prior art 3G GPRS digital cellular telecommunications system;

FIG. 2a is a simplified representation of 3G GPRS protocol stacks of various portions of the system of FIG. 1, and FIG. 2b illustrates a sequence of the successive protocol operations for opening a user data channel between the various portions of FIG. 1;

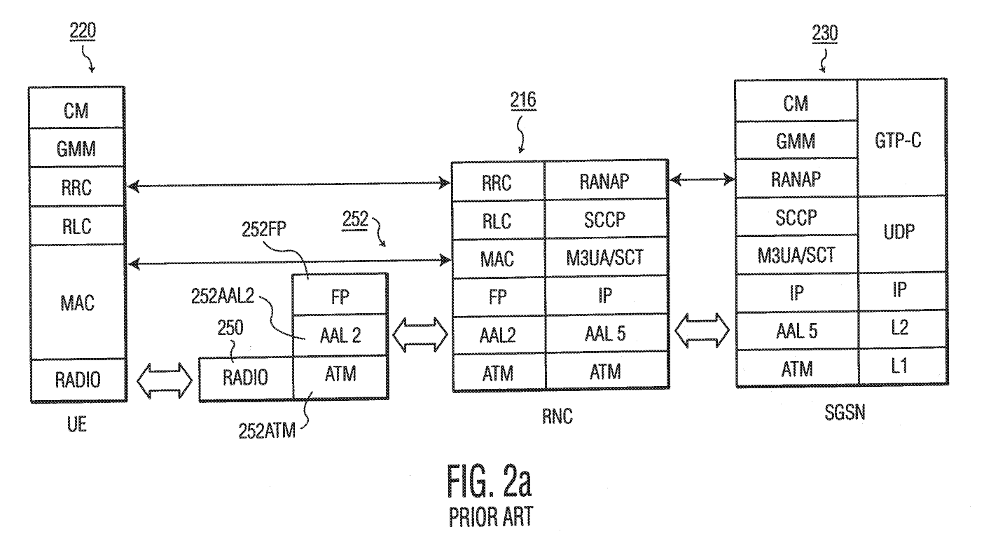

FIG. 3 is a simplified representation of 3G GPRS user data protocol stack;

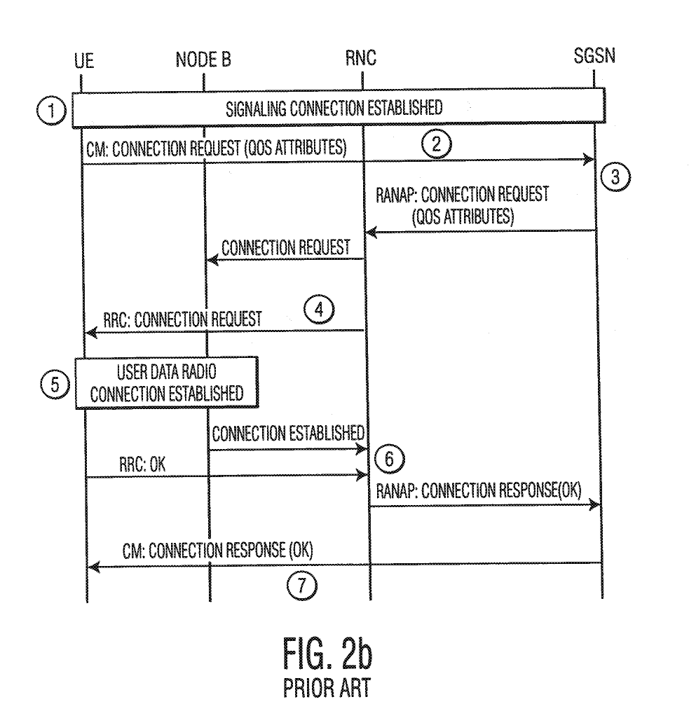

FIG. 4 is a conceptual representation of prior-art 3G-WLAN loose coupling;

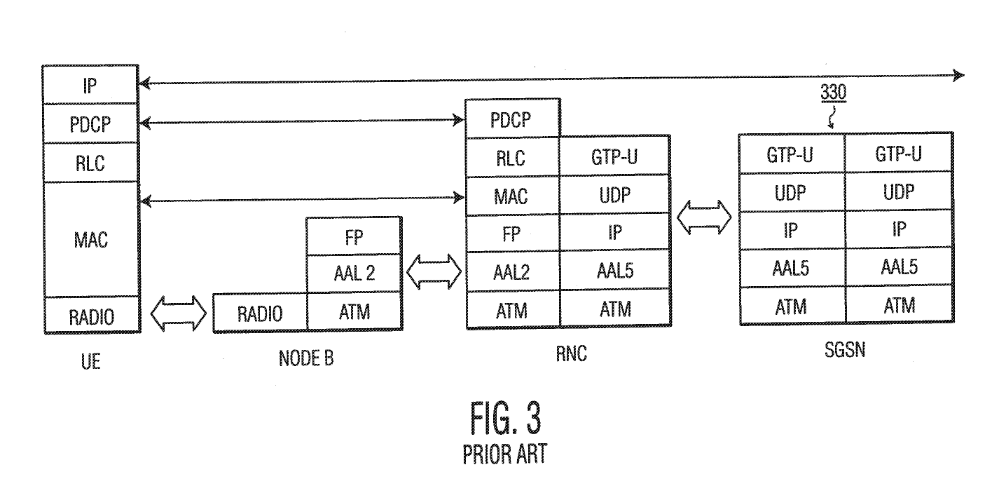

FIG. 5 represents the loose coupling control protocol stacks associated with the mobile terminal, the Access Point (AP), and the AAA server of FIG. 4;

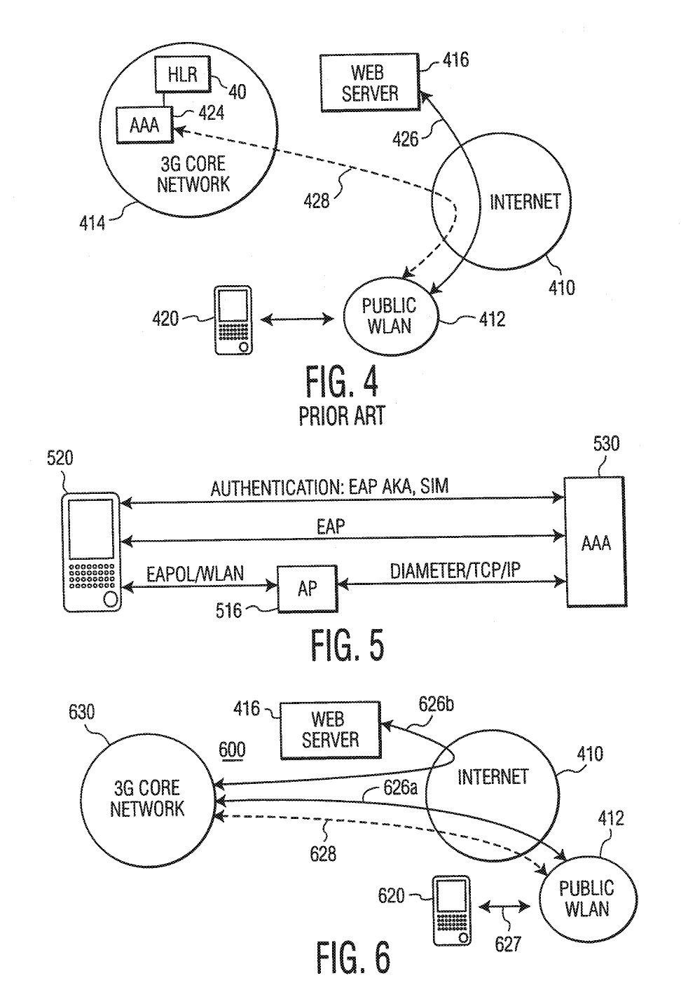

FIG. 6 is a simplified representation of the cellular 3G WLAN tight coupling flow of control information and data as described in the abovementioned Bichot applications;

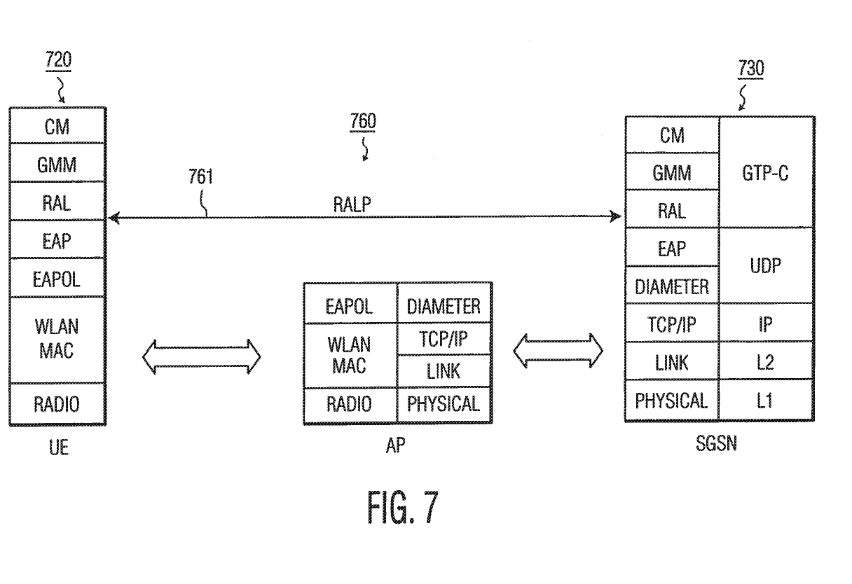

FIGS. 7 and 8 illustrate the control plane and user data plane protocol stacks for enabling the connectivity functions expressed in FIG. 6; and

FIG. 9 illustrates the initial RALP connection method or protocol according to an aspect of the invention.

### DESCRIPTION OF THE INVENTION

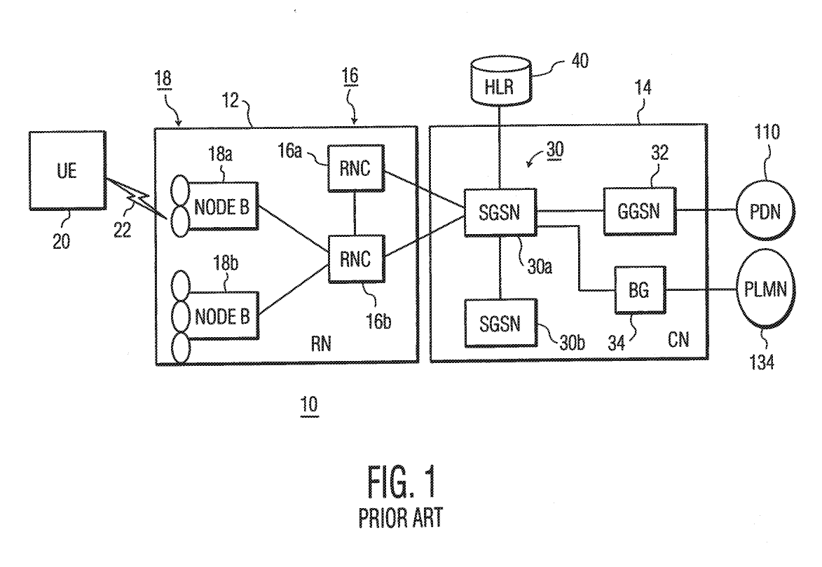

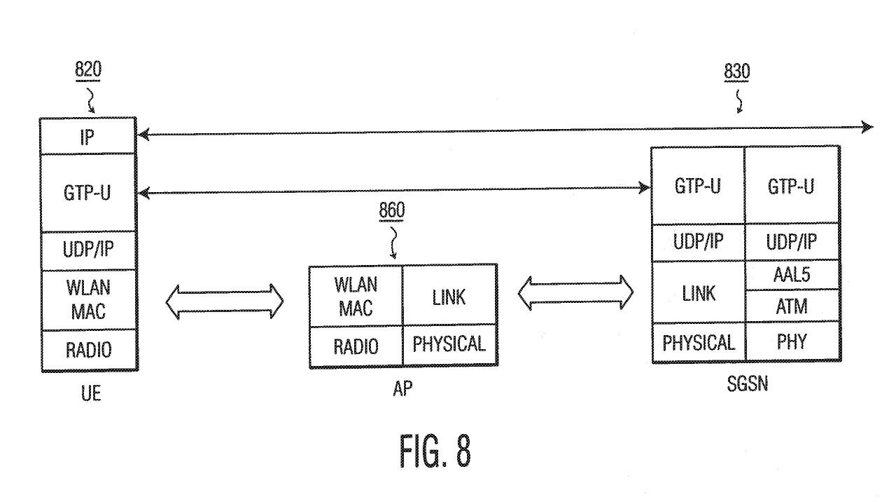

As described in conjunction with FIG. 7, the arrangement of the above-mentioned Bichot application provides protocol stacks in the mobile terminal UE and in the 3G core network (14 of FIG. 1) gateway (SGSN 730 of FIG. 7) which are suitable for control in a tight coupling solution. That solution is based upon signaling (control) flow permanently transported by the EAP (Extended Authentication Protocol) over LAN (EAP/EAPOL) connection. More particularly, when a mobile terminal UE moves into the range of a WLAN or is switched ON in a WLAN, it first establishes an EAP (Extended Authentication Protocol) connection with a remote AAA (Authentication, Authorization, and Accounting) server, which in the example is the SGSN, in conformance with the remote authorization procedure specified by IEEE 802.1X. The Access Point (AP) authorizes only the EAP traffic. The mobile terminal UE is then authenticated by the AAA server according to the 3G GPRS protocol (GMM). When authenticated, the SGSN authorizes the user by sending a DIAMETER message to the access point (AP). The RALP protocol provides extra signaling procedures and conveys other signaling procedures such as Connection Management (CM) in order to establish user data flows.

As mentioned above, EAPOL (EAP over LAN) is a simple standardized (IEEE 802.1X) protocol that is used to carry EAP (Extended Authentication Protocol) packets within Ethernet frames. The EAP is a simple protocol which can be used to carry any kind of authentication protocol. An assumption underlying the system of FIG. 7 is that the signaling (control) connection is initialized using EAP over EAPOL, and remains or persists after the authentication is complete. This maintenance of the EAP over EAPOL connection may not be compliant with the spirit of the EAP specification (RFC2284), and may cause problems with the underlying radio-dependent mechanism (EAPOL), related to efficiency by consuming EAPOL resources continuously, and flexibility in that control of the radio resources could require some quality of service (QOS) requirements which are not possible with EAPOL.

According to an aspect of the invention, part of the signaling or control connection is made over a transport mechanism other than EAP/EAPOL. The initial connection is made over EAP/EAPOL, and, once the authentication phase of control is accomplished, the cellular network gateway (SSGN) delivers to the mobile terminal UE the parameters required to open a new tunnel dedicated to signaling (control) flow. Such a new tunnel may be GTP, for example. The new tunnel provides a path between the mobile terminal UE and the server SGSN for the continued flow of signaling or control information. The EAP/EAPOL path is closed concurrently with the opening of the new tunnel.

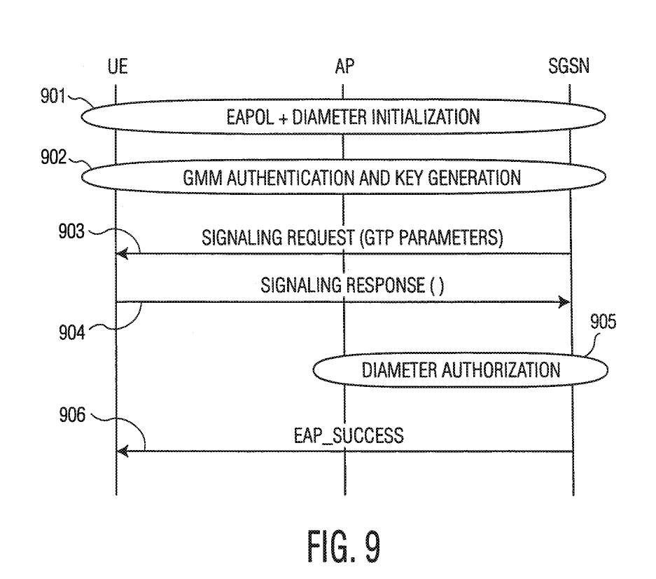

FIG. 9 illustrates the initial RALP connection process according to this aspect of the invention. In FIG. 9, step 901 represents the step of establishing the EAPOL connection, or some equivalent radio mechanism connection, between the mobile terminal UE, Access Point AP, and server SGSN. An end-to-end EAP session is set up in conformance with the remote authentication mechanisms specified by IEEE 802.1x/802.11. Item 902 of FIG. 9 represents the step of performing the authentication procedure. All the signaling or control traffic traverses the system by means of EAP over EAPOL, which is a radio interface and over EAP over DIAMETER, which is a wired interface, which may include the Internet. After the mobile terminal UE is authorized, item 903 of FIG. 9 represents the step of transmitting to the mobile terminal UE of the information required to continue to carry signaling or control signals by way of a dedicated GTP tunnel. In response, the mobile terminal UE can reserve radio resources if needed (when QOS is possible) and establishes the tunnel with or to the server SGSN, using GTP or any other technique. Item 904 represents the step of transmitting by the mobile terminal UE the signals representing acknowledgement of the previous command, and an indication when the tunnel is successfully established. Item 905 represents the step of the server SGSN directing authorization to the access point AP to allow user data traffic from the particular mobile terminal to pass. This step is performed using DIAMETER protocol. Finally, the server SGSN reports to the mobile terminal UE the success or completion of its authorization, as suggested by step item 906 of FIG. 9.

In response to the report of success sent from the server SGSN to the mobile terminal UE as suggested by item 906 of FIG. 9, the mobile terminal closes its EAPOL/EAP connection, and opens another connection as established by the parameters received during step 903 of FIG. 9. For GTP, the parameters are basically an IP address, a tunnel identification, and possibly some QOS parameters. The subsequent signaling or control traffic flows through the new tunnel.

Other embodiments or modes of the invention will be apparent to those skilled in the art. For example, it is essential that the mobile terminal have received the specified tunnel parameters from the server before the EAP/EAPOL path is closed, but the EAP/EAPOL path may be closed before, concurrently with, or after the tunnel is formed. It is probably safer to close the EAP/EAPOL path after the tunnel is formed and its operation verified.

Thus, a method according to an aspect of the invention is for establishing a signaling (control) connection between a client terminal (UE) and a communications network (SGSN). The method comprises the steps of establishing an authentication connection (901; EAPOL+DIAMETER) between the client terminal (UE) and the communications network (SGSN), and transmitting an authentication message (902) from the communications network (SGSN) to the client terminal (UE). The method includes the further step of transmitting (903) set-up parameters from the communications network (SGSN) to the client terminal (UE), where the set-up parameters include information useful for establishing a signaling connection between the client terminal (UE) and the communications network (SGSN) by means of a dedicated tunnel (GTP). The dedicated tunnel (GTP) is established using the set-up parameters. Signaling information is transmitted between the client terminal (UE) and the communications network (SGSN) by way of the dedicated tunnel (GTP), and the authentication connection (901; EAPOL+DIAMETER) is closed. This aspect of the invention may include the step of transmitting (904) from the client terminal (UE) to the communications network (SGSN) acknowledgement of receipt of the set-up parameters. The step of closing the authentication connection may be performed in response to the establishing of the dedicated tunnel.

In a particularly advantageous mode of the method according to this aspect of the invention, the client terminal (UE) is a mobile terminal and the communications network is a 3G network. In such a mode, the step (901) of establishing an authentication connection between the client terminal (UE) and the communications network may be performed by way of a path including a wireless network (AP) which complies with IEEE 802.11 standards. The step of establishing an authentication connection (901) between the client terminal (UE) and the communications network may include the steps of establishing EAPOL and DIAMETER connections. In a particularly advantageous mode of this aspect of the invention, the dedicated tunnel is a GTP tunnel, and the step of transmitting set-up parameters includes the step of transmitting at least one of an IP address and a tunnel ID, and possibly both, and may also include the step of transmitting QOS parameters.

A method according to another aspect of the invention is for implementing tight coupling communications. The method comprises the step of providing a wireless local area network access point (AP) having protocol stacks suitable for operation with a loose coupling arrangement. An EAP/EAPOL connection or path is initially established (901) by way of the wireless local area network access point (AP) between a mobile terminal (UE) and a cellular system server (SGSN). The EAP/EAPOL path is for the flow of authentication and control information, including flow (903) of parameters for a tunnel. Following authentication (902) by the server, the EAP/EAPOL connection is closed, and a corresponding tunnel connection is opened (904) using the parameters. In a particular mode of this method, the step of establishing an EAP/EAPOL connection includes the step of transmitting parameters for a GTP tunnel (903), and the step of opening a corresponding tunnel connection includes the step of opening a GTP tunnel.

1. A method for implementing communications, said method comprising the steps of
providing a wireless local area network access point having protocol stacks;
initially establishing an extended authentication protocol/extended authentication protocol over local area network connection by way of said wireless local area network access point between a mobile terminal and a cellular system server for the flow of authentication and control information including parameters for a control data signaling connection tunnel;
following authentication by said server, closing said extended authentication protocol/extended authentication protocol over local area network connection and opening a corresponding control data signaling connection tunnel using said parameters.

2. The method according to claim 1, wherein said step of establishing an extended authentication protocol/extended authentication protocol over local area network connection includes the step of transmitting parameters for a general packet radio services tunneling protocol tunnel; and
said step of opening a control data signaling connection tunnel includes the step of opening a general packet radio services tunneling protocol tunnel.

3. The method according to claim 1, wherein said step of closing said extended authentication protocol/extended authentication protocol over local area network path is performed after said control data signaling connection tunnel is opened.

4. The method according to claim 1, comprising the further step, following authentication by said server, of transmitting authorization to said access point to pass user data for said mobile terminal.

5. The method according to claim 4, wherein said step of transmitting authorization to said access point is performed using DIAMETER protocol.

6. The method according to claim 1, further comprising the step, following said authentication by said server, of reporting to said mobile terminal the success of said authentication.

7. The method according to claim 1, wherein said step of closing said extended authentication protocol/extended authentication protocol over local area network path is performed before said control data signaling connection tunnel is opened.

8. The method according to claim 1, wherein said step of closing said extended authentication protocol/extended authentication protocol over local area network path is performed concurrently with opening of said control data signaling connection tunnel.
